(19) United States
(12) Patent Application Publication
(10) Pub. No.: US 2022/0215492 A1
(43) Pub. Date: Jul. 7, 2022

(54) SYSTEMS AND METHODS FOR THE COORDINATION OF VALUE-OPTIMIZATING ACTIONS IN PROPERTY MANAGEMENT AND VALUATION PLATFORMS

(71) Applicant: DomiDocs, Inc., Stuart, FL (US)

(72) Inventor: William N. McKenna, IV, Stuart, FL (US)

(21) Appl. No.: 17/569,432

(22) Filed: Jan. 5, 2022

Related U.S. Application Data
(60) Provisional application No. 63/133,860, filed on Jan. 5, 2021.

(51) Int. Cl. G06Q 50/16; G06N 5/04

(52) U.S. Cl. CPC G06Q 50/163; G06N 5/04; G06Q 50/165

(57) ABSTRACT

A system for management, valuation, and orchestration of value optimization actions is provided. The system includes a processor of a property manager node connected over a network to at least one cloud server configured to host a machine learning (ML) module; a memory on which are stored machine-readable instructions that when executed by the processor, cause the processor to: receive property-related data comprising a current valuation of the property and at least one market comparable of the property; provide the property-related data to a machine learning (ML) module for a property model generation; receive at least one predictive output of the property model; and generate at least one property-related recommendation.

### RELATED APPLICATION

Under provisions of 35 U.S.C. § 119(e), the Applicant claim the benefit of U.S. Provisional Application No. 63/133,860, filed Jan. 5, 2021, which is incorporated herein by reference.

### FIELD OF DISCLOSURE

The present disclosure generally relates to systems and methods for the coordination of value-optimizing actions in property management and valuation platforms.

### BACKGROUND

Information about a property, house and/or accommodation such as home value, insurance costs, renovations, and maintenance can be difficult to aggregate, calculate and manage.

In conventional systems, no single entity has a complete collection of real property information. In these conventional systems, it is not practical to create and maintain a single database of all real property information due to businesses, such as mortgage lenders, competing for real property, and retaining such information to support their business practices. Therefore, the desired information collected is often not shared between competitors. Using the conventional systems, accessing, analyzing, and acting on the aforementioned information, especially anticipatorily, can be nearly impossible.

Thus, a conventional strategy may be to store the property information manually, or in online accounts/databases. This often causes problems because the conventional strategy does not contain the sufficient information required to perform proper analysis in order to recommend predictive actions, take preventative measures, and/or make property improvements.

Accordingly, an automated solution for valuing, storing, managing, updating, making recommendations and taking actions based on property information is needed.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for providing value-optimizing actions in a property-related context. The system includes a processor of a property manager node connected over a network to at least one cloud server configured to host a machine learning (ML) module; a memory on which are stored machine-readable instructions that when executed by the processor, cause the processor to: receive property-related data comprising a current valuation of the property and at least one market comparable of the property, provide the property-related data to a machine learning (ML) module for a property model generation, receive at least one predictive output of the property model, and generate at least one property-related recommendation.

Another embodiment of the present disclosure provides a method for providing value-optimizing actions in a property-related context. The method includes: receiving, by a property manager node, property-related data comprising a current valuation of the property and at least one market comparable of the property, providing, by the property manager node, the property-related data to a machine learning (ML) module for a property model generation, receiving, by the property manager node, at least one predictive output of the property model, and generating, by the property manager node, a property-related recommendation.

Another embodiment of the present disclosure provides a computer-readable medium including instructions for receiving property-related data comprising a current valuation of the property and at least one market comparable of the property, providing the property-related data to a machine learning (ML) module for a property model generation, receiving at least one predictive output of the property model, and generating a property-related recommendation.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an embodiment of a property management, valuation, and recommendation platform;

FIG. 2 illustrates a diagram of a property life cycle value system;

FIG. 3A illustrates a property life cycle value report;

FIG. 3B illustrates an expected replacement report;

FIG. 4 illustrates a network diagram of a system including detailed features of a property manager server node consistent with the present disclosure;

FIG. 5 illustrates a method for providing value-optimizing actions in a property-related context; and

FIG. 6 illustrates a block diagram of a computing device consistent with embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of property management, embodiments of the present disclosure are not limited to use only in this context.

The present disclosure may provide a system and method (collectively referred to herein as the “platform”) for identifying events for real properties, determining the likelihood of fraud, and/or alerting the consumer with suggested actions.

A challenge of monitoring real property is that no two properties are alike. The entities that manage each facet such as, for example, mortgage and/or insurance are different for each property. The present disclosure may allow a model to be applied to individual properties.

Accordingly, consistent with various embodiments provided herein, a single model can also be applied to a group of properties. This is useful when, by way of non-limiting example, a home builder needs to monitor a group of homes. The present disclosure may also be used, by way of non-limiting example, to monitor the status of all of the units in a condominium situation.

In some embodiments of the present disclosure, the platform and/or model may employ a single mechanism to:
a. Control how events may be collected, and/or
b. Evaluate if events may be a threat.

The technical advantages of the various embodiments disclosed herein, may include, but not be limited to, for example:
a. Ease in modification of the platform and/or model over time,
b. Selectiveness on a per-property basis, and/or
c. Ability to assign values dynamically.

Businesses may require accommodation of data processing changes. With the present disclosure, new business relationships or special data processing requirements can be defined without affecting other business arrangements.

Models may be assigned to a real property manually or dynamically. In the dynamic situation, a situation may be detected and the remedy for the situation may be, for example, but not be limited to, the assignment of a different model. An example of this may be detecting a potential problem and having the present disclosure increase the intensity of detection of adjusting the thresholds of events for real properties used for evaluation.

Fur more, embodiments of the present disclosure concern home valuation and optimization of the value. For example, embodiments may be configured to orchestrate value optimizing actions by way of a platform that performs, by way of non-limiting example, one or more of the following: a) studies correlations, using machine learning, of properties, b) recommends improvements/risk mitigation/changes to properties, c) orchestrates third party actions between home owner and service providers in furtherance of those recommendations, d) tracks the completion of the actions through blockchain based data-disclosure and certification of completions tied to the property, and e) updates a value index based on certified completion of work.

In a first aspect, embodiments may provide a platform configured to:
a. calculate a Value of a Property based on life-cycle model;
b. adjusts valuation based on market comps for home improvements document by the homeowner;
c. leverage a knowledge base to accurately defend the life-cycle;
d. process with machine learning capabilities; and
e. returns ROI projections and analytics on how improvements affect market prices.

In a second aspect, embodiments may provide a platform configured to:

receive a value index;
a. calculate ROI based on machine learning in the industry of remodeling homes;
b. orchestrate multiple parties surrounding the process of establishing and optimizing home valuations;
c. enable the coordination of third-party actions based on what is believed to maximize the home value, including scheduling of vendors, e.g., appraisals and repairs;
d. track through blockchain certificates completion and validation of work; and
e. update a value index.

In a third aspect, embodiments may provide a platform configured to:
a. capture the UI/UX aspect of a property; and
b. enable the homeowner to digitally showcase the improvements of the property o Appraisers and Prospective Buyers

In a fourth aspect, embodiments may provide a platform configured to:

Combine:
a. Third Party Data,
b. Public Data, and
c. Private Data; and

Generate a Disclosure Document comprising:
a. ID,
b. Activation*,
c. Termination*,
d. Owner Info, and
e. Recipient Info.

The elements marked as (*) may be operable through End User Control of access to Public/Private Key Pair. In this way, the platform may be configured to achieve consent based on the utilization of the Public/Private Key Pair, of any latest disclosure documentation version published to, for example, a blockchain.

In a fifth aspect, embodiments may provide a platform configured to provide Smart Contract Based Document/Report Tracking. This aspect may couples Aspect 4 with Aspect 2 in order to:
a. track vendor performance,
b. enforce smart contracts,
c. serve as custodian of reports generated by Vendors, and
d. publish for purposes of Value Index Calculation in Aspect 1 above.

Embodiments of the present disclosure may comprise methods, systems, and a computer readable medium. Details with regards to each system entity is provided below. Although some modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may comprise at least those architectural components as found in computing device 600.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method.

Although the aforementioned method has been described to be performed by the platform 100, it should be understood that computing device 600 may be used to perform the various stages of the method. Furthermore, in some embodiments, different operations may be performed by different networked elements in operative communication with computing device 600. For example, a plurality of computing devices may be employed in the performance of some or all of the stages in the aforementioned method. Moreover, a plurality of computing devices may be configured much like a single computing device 600. Similarly, an apparatus may be employed in the performance of some or all stages in the method. The apparatus may also be configured much like computing device 600.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

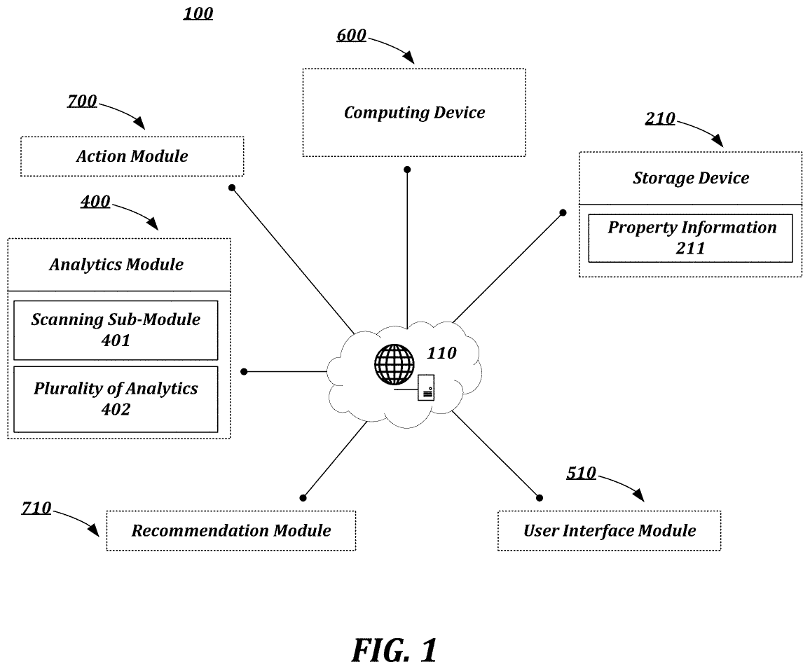

FIG. 1 illustrates one possible operating environment through which a platform consistent with embodiments of the present disclosure. By way of non-limiting example, a property valuation and recommendation platform 100 may be hosted on, for example, a cloud computing service. In some embodiments, the platform 100 may be hosted on the computing device 600. A user may access the platform 100 through an application or via a hardware device. The application may be implemented as, for example, but not be limited to, a website, a web application, a desktop application, and a mobile application compatible with the computing device 600. One possible embodiment of the application and/or hardware device may be provided by the DomiDocs™ and TrueValue Index™ suite of products and services provided by DomiDocs, Inc.

FIG. 1 illustrates one possible operating environment through which a platform 100 consistent with embodiments of the present disclosure may be provided. By way of non-limiting example, the platform 100 may be hosted in both a blockchain protocol (“on-chain”) and off of a blockchain protocol (“off-chain”). One possible embodiment of the platform may be provided by the TrueValue Index™ protocol provided by DomiDocs, Inc. It should be understood that layers and stages performed by the layers may be either “on-chain” or “off-chain.” The present disclosure anticipates embodiments with variations as to which stages may be performed “on-chain” or “off-chain.”

Accordingly, embodiments of the present disclosure provide a platform comprised of a distributed set of computing elements, including, but not limited to computing device 600. FIG. 1 illustrates an analytics module 400 consistent with embodiments of the present disclosure. In some embodiments, the analytics module 400 may include various sets of property information. In some embodiments, the property information may include calculated property data. In some embodiments, the calculated property data may include the following: prior property value information, a plurality of property values in a predetermined area, insurance cost information, financing information, and property tax information, etc.

In further embodiments, the property information may include physical property data. In some embodiments, the physical property data may include information about a physical property item(s). In some embodiments, the physical property data and/or the physical property item(s) may include at least one of the following: warranty information, appliance information, a floor plan, roofing information, exterior features of structures, exterior improvements of structures, interior amenities of structures, interior improvements of structures, renovations, property events, land descriptions (i.e., surveys), structures located on the property, and claims made against the property (liens).

In further embodiments, the analytics module 400 may include a scanning sub-module 401. In some embodiments, the sub-module 401 may be configured to analyze the property information. In further embodiments, the scanning sub-module 401 may employ optical character recognition (OCR). In yet further embodiments, the scanning module may be directed to only locations that are likely to have relevant information. In still further embodiments, the scanning sub-module 401 may be configured to search for changes to, for example: liens, zoning, property taxes, local crime data, Homeowners Association (HOA) agreements, vacancies, property listings, loan requests, and insurance claims.

In even further embodiments, the scanning sub-module 401 may be configured to search a plurality of external databases for the property information. A plurality of the external databases may include, for example, publicly available property listings and tax records. In yet still further embodiments, the scanning sub-module 401 may be configured to convert and/or transform the plurality of property information in to readable, searchable, and/or organizable data. In yet still further embodiments, the scanning sub-module 401 may be configured to search, via customized logic, through the large sets of property information. By way of nonlimiting example, the searching may be conducted on multiple internet sites and scanned for advertisements of properties for sale or rent. To further the example, a specification by region of the country or by type of home may be enabled.

In yet further embodiments, the analytics module 400 may be configured to generate a plurality of analytics 402 based on the analyzed property information. In some embodiments, the plurality of analytics 402 may be calculated based on the various property information. In further embodiments, the plurality of analytics 402 may include a current value of a property. In yet further embodiments, the plurality of analytics 402 may comprise an estimated future value of the property. In still further embodiments, the plurality of analytics 402 may include a return on investment (ROI) projection of a property improvement. In yet still further embodiments, the plurality of analytics 402 may include a projected change in property value based on a real and/or simulated event.

In yet further embodiments, the plurality of analytics 402 may include a property life cycle value report. In some embodiments, the property life cycle value report may include an original cost of a physical property item. In further embodiments, the property life cycle value report may include a number of years of usefulness of the of at least one physical property item. In yet further embodiments, the property life cycle value report may include an amount and/or percentage of depreciation of the physical property item. In still further embodiments, the property life cycle value report may include a residual value of the physical property item. In even further embodiments, the property life cycle value report may include a life cycle value of the of the physical property item.

In even yet still further embodiments, the plurality of analytics 402 may include an expected replacement report. In some embodiments, the expected replacement report may include a cost of replacing the property item. In some embodiments, the expected replacement report may include a recommended date of replacing the physical property item.

FIG. 1 illustrates a recommendation module 710 consistent with embodiments of the present disclosure. In some embodiments, the recommendation module may be configured to recommend, based on the plurality of analytics, the following: a property improvement, a maintenance schedule for at least a portion of the property, a risk mitigation, and a change to the property.

In some embodiments, a maintenance schedule for a portion of the property may indicate one or more maintenance activity performable in accordance with the physical property information. In further embodiments, the maintenance schedule may further indicate one or more sources of procuring of a consumable product and a recurring service associated with the maintenance activity. In some embodiments, a risk mitigation may include a preventative measure(s) to protect from a possible damaging future event and/or liability.

FIG. 1 illustrates an action module 700 consistent with embodiments of the present disclosure. In some embodiments, the action module 700 may be configured to orchestrate a third-party action between a property owner and a service provider in furtherance of the recommendation. In some embodiments, the service provider may include at least one of the following: an appraiser, a contractor, a surveyor, a taxing authority, an insurance company, an appliance manufacturer, and a real estate professional. In some embodiments, the service provider may be assigned in accordance with a warranty claim.

In some embodiments, orchestrating the third-party action between a property owner and a service provider in furtherance of the recommendation may include performing a maintenance request based on the maintenance schedule. In further embodiments, the action module 700 may be configured to track the completion of the actions tied to the property using a blockchain-based data disclosure and/or a certification of completeness. In yet further embodiments, the action module 700 may be configured to update the property value. In some embodiments, the update of the property value may be based on the certified completion of the work.

In yet further embodiments, the action module 700 may include a scheduling sub-module (not illustrated in the figures). In some embodiments, the scheduling sub-module may be configured to schedule the third-party action between a property owner and a service provider. In further embodiments, the scheduling sub-module may allow the property owner and/or service provider to modify the date and/or time of the third-party action. In further embodiments, the scheduling sub-module may be automated. By way of nonlimiting example, upon an acceptance of a maintenance request, the scheduling sub-module may schedule the service provider in accordance with the property owner's approved timeframes.

FIG. 1 illustrates a User Interface (UI) module 500 consistent with embodiments of the present disclosure. In some embodiments, the UI module 500 may be configured to allow a user to access a storage device 210, the analytics module 400, and the recommendation module 710. In some embodiments, the user may be: a property owner, an appraiser, a surveyor, a service provider, an appliance manufacturer, a taxing authority, a prospective buyer, a real estate professional, and a contractor.

In further embodiments, the user may use the platform to manage various properties and/or subunits of the properties. In yet further embodiments, the user may employ the platform to specify the projects associated with each property. In further embodiments, the UI module 500 may enable a first user to interact with a second user. In yet further embodiments, the UI module 500 may be configured to allow the user to upload, access and/or update the property information 211 to the storage device 210. In still further embodiments, the UI module 500 may allow the user to manage a plurality of third-party actions between a property owner and a service provider.

FIG. 1 illustrates a storage device 210 consistent with embodiments of the present disclosure. In some embodiments, the storage device 210 may be configured to store the property information 211. In some embodiments, the storage device may be implemented on the computing device 600.

Embodiments of the present disclosure provide a platform operative by a set of methods and computer-readable media including instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

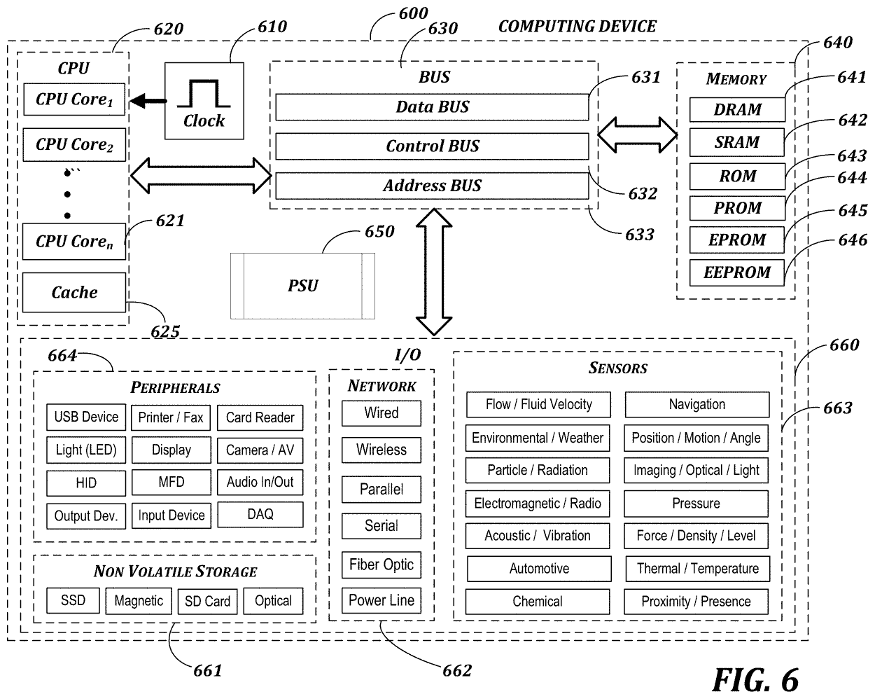

For example, although methods may be described to be performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may include at least those architectural components as found in computing device 600 described in more detail in FIG. 6 discussed below.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

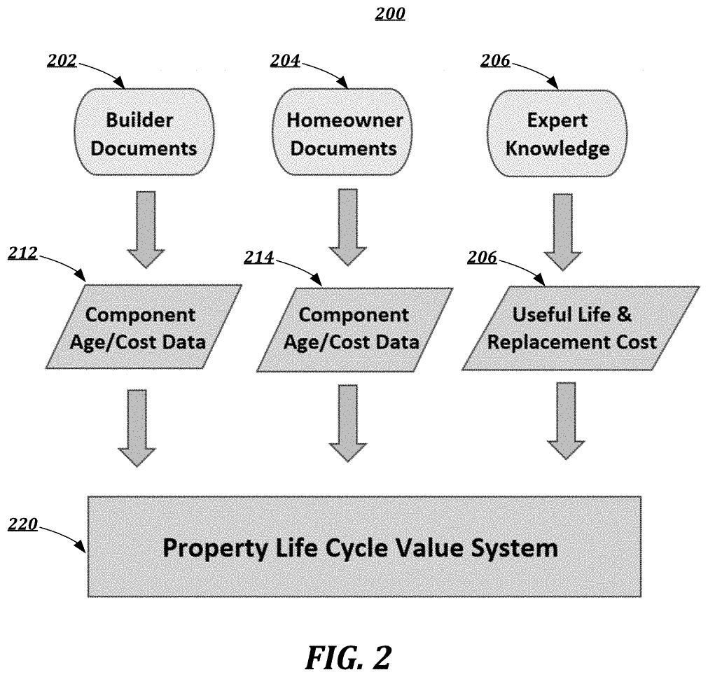

FIG. 2 illustrates a diagram of a property life cycle value system consistent with the embodiments of the present disclosure.

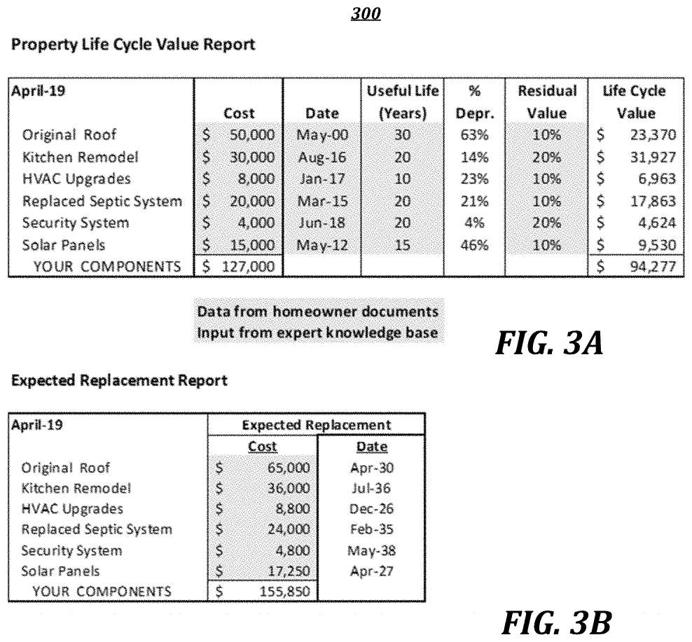

Referring to FIG. 2, a Property Life Cycle Value System 210 incorporates builder documents 202 including corresponding component age/cost data 212, homeowner documents 204 including corresponding component age/cost data 214 and expert knowledge data 206 including useful life and replacement costs data 206. The Property Life Cycle Value System 210 is further disclosed in FIGS. 3A and 3B depicting a property life cycle value report and an expected replacement report, respectively.

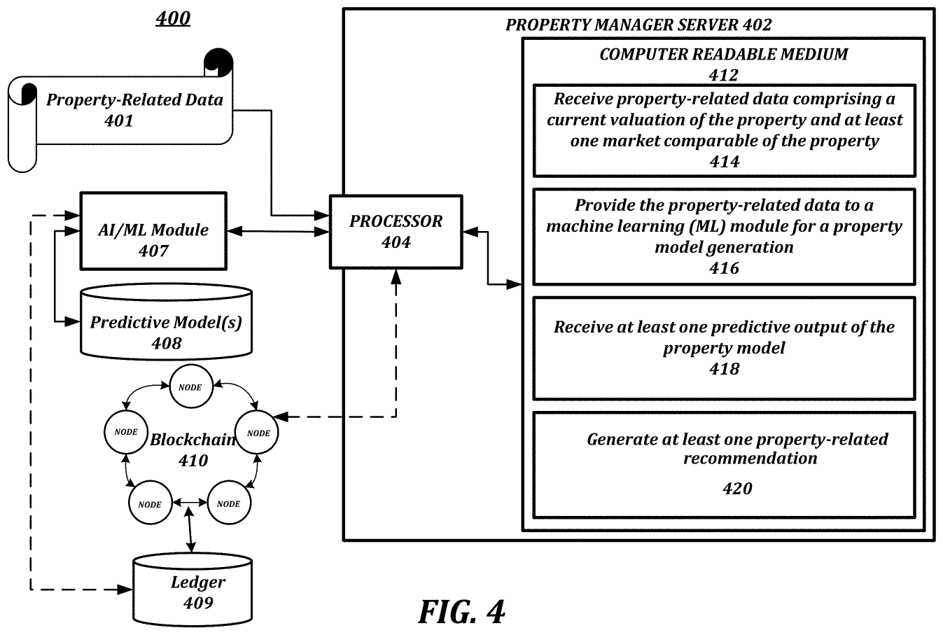

FIG. 4 illustrates a network diagram of a system including detailed features of a property manager server node consistent with the present disclosure.

Referring to FIG. 4, the example network 400 includes the property manager server node 402 connected to one or more cloud server nodes (not shown) over a network. The cloud server node(s) may be configured to host an AI/ML module 407. The property manager server node 402 may receive property-related data.

The AI/ML module 407 may generate a predictive model(s) 408 based on pre-processed property-related data provided by property manager server node 402 from a local data storage (not shown) hosted on the property manager server node 402. The property-related data may be recorded on a permissioned blockchain 410 ledger 409. The AI/ML module 407 may provide predictive outputs data that indicate property-related recommendations. Note that in one embodiment, the AI/ML module 407 may be implemented on the property manager server node 402. The property manager server node 402 may process the predictive outputs data received from the AI/ML module 407 to generate notifications and/or recommendations to a user. The AI/ML module 408 may be configured to codify deterministic relationships characterizing known profiles/trends of any property that may be analyzed. In one embodiment, the AI/ML module 408 may use an underlying neural network for generation of the predictive models 408.

While this example describes in detail only one property manager server node 402, multiple such nodes may be connected to the network and/or to the blockchain 410. It should be understood that the property manager server node 402 may include additional components and that some of the components described herein may be removed and/or modified without departing from a scope of the property manager server node 402 disclosed herein. The property manager server node 402 may be a computing device 600 in FIG. 1 or a server computer, or the like, and may include a processor 404, which may be a semiconductor-based microprocessor, a central processing unit (CPU), an application specific integrated circuit (ASIC), a field-programmable gate array (FPGA), and/or another hardware device. Although a single processor 404 is depicted, it should be understood that the design server node 102 may include multiple processors, multiple cores, or the like, without departing from the scope of the property manager server node 402 system.

The property manager server node 402 may also include a non-transitory computer readable medium 412 that may have stored thereon machine-readable instructions executable by the processor 404. Examples of the machine-readable instructions are shown as 414-220 and are further discussed below. Examples of the non-transitory computer readable medium 412 may include an electronic, magnetic, optical, or other physical storage device that contains or stores executable instructions. For example, the non-transitory computer readable medium 412 may be a Random-Access memory (RAM), an Electrically Erasable Programmable Read-Only Memory (EEPROM), a hard disk, an optical disc, or other type of storage device.

The processor 404 may fetch, decode, and execute the machine-readable instructions 414 to receive property-related data comprising a current valuation of the property and at least one market comparable of the property. The processor 404 may fetch, decode, and execute the machine-readable instructions 416 to provide the property-related data to a machine learning (ML) module for a property model generation. The processor 404 may fetch, decode, and execute the machine-readable instructions 418 to receive at least one predictive output of the property model. The processor 404 may fetch, decode, and execute the machine-readable instructions 420 to generate at least one property-related recommendation. The permissioned blockchain 410 may be configured to use one or more smart contracts that manage transactions for multiple participating nodes.

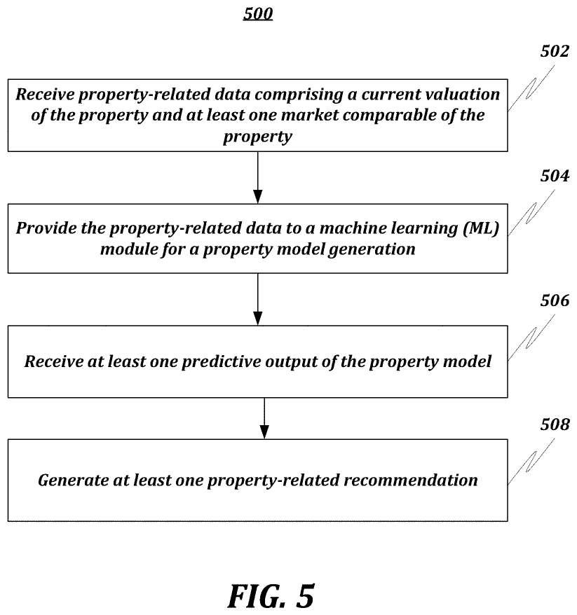

FIG. 5 illustrates a flowchart of a method consistent with the present disclosure.

Referring to FIG. 5, the method 500 may include one or more of the steps described below. FIG. 5 illustrates a flow chart of an example method executed by the property manager server node 402 (see FIG. 4). It should be understood that method 500 depicted in FIG. 5 may include additional operations and that some of the operations described therein may be removed and/or modified without departing from the scope of the method 500. The description of the method 500 is also made with reference to the features depicted in FIG. 4 for purposes of illustration. Particularly, the processor 404 of the design server 402 may execute some or all of the operations included in the method 500.

With reference to FIG. 5, at block 502, the processor 404 may receive property-related data comprising a current valuation of the property and at least one market comparable of the property. At block 504, the processor 404 may provide the property-related data to a machine learning (ML) module for a property model generation. At block 506, the processor 404 may receive at least one predictive output of the property model. At block 508, the processor 504 may generate at least one property-related recommendation.

Consistent with embodiments of the present disclosure, a method for providing value-optimizing actions in a property-related context may be performed by at least one of the aforementioned modules. The method may be implemented as, for example, but not limited to, computer instructions, which when executed, perform the method.

FIG. 6 is a block diagram of a system including a computing device 600. As discussed above, the platform 100 may be implemented as, for example, but not be limited to, a website, a web application, a desktop application, backend application, and a mobile application compatible with a computing device 600. The computing device 600 may include, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although the method 500 has been described to be performed by a computing device 600, it should be understood that, in some embodiments, different operations may be performed by a plurality of the computing devices 600 in operative communication at least one network.

Embodiments of the present disclosure may comprise a system having a central processing unit (CPU) 620, a bus 630, a memory unit 640, a power supply unit (PSU) 650, and one or more Input/Output (I/O) units. The CPU 620 coupled to the memory unit 640 and the plurality of I/O units 660 via the bus 630, all of which are powered by the PSU 650. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 620, the bus 630, the memory unit 640, a PSU 650, and the plurality of I/O units 660 may be implemented in a computing device, such as computing device 600 of FIG. 6. Any suitable combination of hardware, software, or firmware may be used to implement the aforementioned units. For example, the CPU 620, the bus 630, and the memory unit 640 may be implemented with computing device 600 or any of other computing devices 600, in combination with computing device 600. The aforementioned system, device, and components are examples and other systems, devices, and components may comprise the aforementioned CPU 620, the bus 630, the memory unit 640, consistent with embodiments of the disclosure.

At least one computing device 600 may be embodied as any of the computing elements illustrated in all of the attached figures, including the Storage Device; the Analytics Module; the Recommendation Module; the User Interface (UI) Module; the Method for Orchestrating a Third-Party Action; and the Method for Recommending a Property Improvement. A computing device 600 does not need to be electronic, nor even have a CPU 620, nor bus 630, nor memory unit 640. The definition of the computing device 600 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 600, especially if the processing is purposeful.

With reference to FIG. 6, a system consistent with an embodiment of the disclosure may include a computing device, such as computing device 600. In a basic configuration, computing device 600 may include at least one clock module 610, at least one CPU 620, at least one bus 630, and at least one memory unit 640, at least one PSU 650, and at least one I/O 660 module, wherein I/O module may be comprised of, but not limited to a non-volatile storage sub-module 661, a communication sub-module 662, a sensors sub-module 663, and a peripherals sub-module 664.

A system consistent with an embodiment of the disclosure the computing device 600 may include the clock module 610 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling ata rate slower than the worst-case internal propagation delays. The preeminent example of the aforementioned integrated circuit is the CPU 620, the central component of modern computers, which relies on a clock. The only exceptions are asynchronous circuits such as asynchronous CPUs. The clock 610 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 600 use a “clock multiplier” which multiplies a lower frequency external clock to the appropriate clock rate of the CPU 620. This allows the CPU 620 to operate at a much higher frequency than the rest of the computer, which affords performance gains in situations where the CPU 620 does not need to wait on an external factor (like memory 640 or input/output 660). Some embodiments of the clock 610 may include dynamic frequency change, where, the time between clock edges can vary widely from one edge to the next and back again.

A system consistent with an embodiment of the disclosure the computing device 600 may include the CPU unit 620 comprising at least one CPU Core 621. A plurality of CPU cores 621 may comprise identical CPU cores 621, such as, but not limited to, homogeneous multi-core systems. It is also possible for the plurality of CPU cores 621 to comprise different CPU cores 621, such as, but not limited to, heterogeneous multi-core systems, big.LITTLE systems and some AMD accelerated processing units (APU). The CPU unit 620 reads and executes program instructions which may be used across many application domains, for example, but not limited to, general purpose computing, embedded computing, network computing, digital signal processing (DSP), and graphics processing (GPU). The CPU unit 620 may run multiple instructions on separate CPU cores 621 at the same time. The CPU unit 620 may be integrated into at least one of a single integrated circuit die and multiple dies in a single chip package. The single integrated circuit die and multiple dies in a single chip package may contain a plurality of other aspects of the computing device 600, for example, but not limited to, the clock 610, the CPU 620, the bus 630, the memory 640, and I/O 660.

The CPU unit 620 may contain cache 622 such as, but not limited to, a level 1 cache, level 2 cache, level 3 cache or combination thereof. The aforementioned cache 622 may or may not be shared amongst a plurality of CPU cores 621. The cache 622 sharing comprises at least one of message passing and inter-core communication methods may be used for the at least one CPU Core 621 to communicate with the cache 622. The inter-core communication methods may comprise, but not limited to, bus, ring, two-dimensional mesh, and crossbar. The aforementioned CPU unit 620 may employ symmetric multiprocessing (SMP) design.

The plurality of the aforementioned CPU cores 621 may comprise soft microprocessor cores on a single field programmable gate array (FPGA), such as semiconductor intellectual property cores (IP Core). The plurality of CPU cores 621 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 621, for example, but not limited to Instruction-level parallelism (ILP) such as, but not limited to, superscalar pipelining, and Thread-level parallelism (TLP).

Consistent with the embodiments of the present disclosure, the aforementioned computing device 600 may employ a communication system that transfers data between components inside the aforementioned computing device 600, and/or the plurality of computing devices 600. The aforementioned communication system will be known to a person having ordinary skill in the art as a bus 630. The bus 630 may embody internal and/or external plurality of hardware and software components, for example, but not limited to a wire, optical fiber, communication protocols, and any physical arrangement that provides the same logical function as a parallel electrical bus. The bus 630 may comprise at least one of, but not limited to a parallel bus, wherein the parallel bus carry data words in parallel on multiple wires, and a serial bus, wherein the serial bus carry data in bit-serial form. The bus 630 may embody a plurality of topologies, for example, but not limited to, a multidrop/electrical parallel topology, a daisy chain topology, and a connected by switched hubs, such as USB bus. The bus 630 may comprise a plurality of embodiments, for example, but not limited to:
Internal data bus (data bus) 631/Memory bus
Control bus 632
Address bus 633
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidlO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 600 may employ hardware integrated circuits that store information for immediate use in the computing device 600, know to the person having ordinary skill in the art as primary storage or memory 640. The memory 640 operates at high speed, distinguishing it from the non-volatile storage sub-module 661, which may be referred to as secondary or tertiary storage, which provides slow-to-access information but offers higher capacities at lower cost. The contents contained in memory 640, may be transferred to secondary storage via techniques such as, but not limited to, virtual memory and swap. The memory 640 may be associated with addressable semiconductor memory, such as integrated circuits consisting of silicon-based transistors, used for example as primary storage but also other purposes in the computing device 600. The memory 640 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 641, Static Random-Access Memory (SRAM) 642, CPU Cache memory 625, Advanced Random-Access Memory (A-RAM), and other types of primary storage such as Random-Access Memory (RAM).
Non-volatile memory which can retain stored information even after power is removed, for example, but not limited to, Read-Only Memory (ROM) 643, Programmable ROM (PROM) 644, Erasable PROM (EPROM) 645, Electrically Erasable PROM (EEPROM) 646 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 600 may employ the communication system between an information processing system, such as the computing device 600, and the outside world, for example, but not limited to, human, environment, and another computing device 600. The aforementioned communication system will be known to a person having ordinary skill in the art as I/O 660. The I/O module 660 regulates a plurality of inputs and outputs with regard to the computing device 600, wherein the inputs are a plurality of signals and data received by the computing device 600, and the outputs are the plurality of signals and data sent from the computing device 600. The I/O module 660 interfaces a plurality of hardware, such as, but not limited to, non-volatile storage 661, communication devices 662, sensors 663, and peripherals 664. The plurality of hardware is used by the at least one of, but not limited to, human, environment, and another computing device 600 to communicate with the present computing device 600. The I/O module 660 may comprise a plurality of forms, for example, but not limited to channel I/O, port mapped I/O, asynchronous I/O, and Direct Memory Access (DMA).

Consistent with the embodiments of the present disclosure, the aforementioned computing device 600 may employ the non-volatile storage sub-module 661, which may be referred to by a person having ordinary skill in the art as one of secondary storage, external memory, tertiary storage, off-line storage, and auxiliary storage. The non-volatile storage sub-module 661 may not be accessed directly by the CPU 620 without using intermediate area in the memory 640. The non-volatile storage sub-module 661 does not lose data when power is removed and may be two orders of magnitude less costly than storage used in memory module, at the expense of speed and latency. The non-volatile storage sub-module 661 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (661) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 600 may employ the communication sub-module 662 as a subset of the I/O 660, which may be referred to by a person having ordinary skill in the art as at least one of, but not limited to, computer network, data network, and network. The network allows computing devices 600 to exchange data using connections, which may be known to a person having ordinary skill in the art as data links, between network nodes. The nodes comprise network computer devices 600 that originate, route, and terminate data. The nodes are identified by network addresses and can include a plurality of hosts consistent with the embodiments of a computing device 600. The aforementioned embodiments include, but not limited to personal computers, phones, servers, drones, and networking devices such as, but not limited to, hubs, switches, routers, modems, and firewalls.

Two nodes can be said are networked together, when one computing device 600 is able to exchange information with the other computing device 600, whether or not they have a direct connection with each other. The communication sub-module 662 supports a plurality of applications and services, such as, but not limited to World Wide Web (WWW), digital video and audio, shared use of application and storage computing devices 600, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 602, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 662 may comprise a plurality of size, topology, traffic control mechanism and organizational intent. The communication sub-module 662 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 602.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 600 may employ the sensors sub-module 663 as a subset of the I/O 660. The sensors sub-module 663 comprises at least one of the devices, modules, and subsystems whose purpose is to detect events or changes in its environment and send the information to the computing device 600. Sensors are sensitive to the measured property, are not sensitive to any property not measured, but may be encountered in its application, and do not significantly influence the measured property. The sensors sub-module 663 may comprise a plurality of digital devices and analog devices, wherein if an analog device is used, an Analog to Digital (A-to-D) converter must be employed to interface the said device with the computing device 600. The sensors may be subject to a plurality of deviations that limit sensor accuracy. The sensors sub-module 663 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 600 may employ the peripherals sub-module 662 as a subset of the I/O 660. The peripheral sub-module 664 comprises ancillary devices uses to put information into and get information out of the computing device 600. There are 3 categories of devices comprising the peripheral sub-module 664, which exist based on their relationship with the computing device 600, input devices, output devices, and input/output devices. Input devices send at least one of data and instructions to the computing device 600. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 600. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 664:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 600. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 600 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 600. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 662 sub-module), data storage device (non-volatile storage 661), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for providing value-optimizing actions in a property-related context, the system comprising:
a processor of a property manager node connected over a network to at least one cloud server configured to host a machine learning (ML) module;
a memory on which are stored machine-readable instructions that when executed by the processor, cause the processor to:
receive property-related data comprising a current valuation of the property and at least one market comparable of the property;
provide the property-related data to a machine learning (ML) module for a property model generation;
receive at least one predictive output of the property model; and
generate at least one property-related recommendation, wherein the at least one property-related recommendation comprises a value-optimizing action.

2. The system of claim 1, wherein the instructions further cause the processor to derive calculated property data and physical property information from the property-related data,
wherein the calculated property data comprises any of: a prior property value, a plurality of property values in a predetermined area, insurance cost data, and property tax data; and
wherein the physical property information comprises any of: warranty data, appliance data, roofing data, exterior improvements data, interior improvements data, renovations data, and property events data.

3. The system of claim 1, wherein the instructions further cause the processor to generate analytics data based on the property-related data, wherein the analytics comprising a current value of the property and an estimated future value of a property.

4. The system of claim 3, wherein the instructions further cause the processor to generate the at least one property-related recommendation based on the analytics data, wherein the at least one property-related recommendation comprises any of: a property improvement, a maintenance schedule, a risk mitigation action, and a modification to the property.

5. The system of claim 1, wherein the instructions further cause the processor to, responsive to the at least one property-related recommendation, orchestrate a third-party action between a property owner and a service provider.

6. The system of claim 5, wherein the instructions further cause the processor to track a completion of the third-party actions based on a blockchain transaction data and a certification of completion.

7. The system of claim 6, wherein the instructions further cause the processor to update the property value based on the blockchain transaction data and the certification of completion.

8. A method for providing value-optimizing actions in a property-related context, the method comprising:
receiving, by a property manager node, property-related data comprising a current valuation of the property and at least one market comparable of the property;
providing, by the property manager node, the property-related data to a machine learning (ML) module for a property model generation;
receiving, by the property manager node, at least one predictive output of the property model; and
generating, by the property manager node, a property-related recommendation for property-related value optimization.

9. The method of claim 8, further comprising generating a return on investment (ROI) projection based on the property-related recommendation.

10. The method of claim 8, further comprising derive calculated property data and physical property information from the property-related data,
wherein the calculated property data comprises any of: a prior property value, a plurality of property values in a predetermined area, insurance cost data, and property tax data; and
wherein the physical property information comprises any of: warranty data, appliance data, roofing data, exterior improvements data, interior improvements data, renovations data, and property events data.

11. The method of claim 8, further comprising generating analytics data based on the property-related data, wherein the analytics comprising a current value of the property and an estimated future value of a property.

12. The method of claim 11, further comprising generating the at least one property-related recommendation based on the analytics data, wherein the at least one property-related recommendation comprises any of: a property improvement, a maintenance schedule, a risk mitigation action, and a modification to the property.

13. The method of claim 8, further comprising, responsive to the at least one property-related recommendation, orchestrating a third-party action between a property owner and a service provider.

14. The method of claim 13, further comprising tracking a completion of the third-party actions based on a blockchain transaction data and a certification of completion.

15. The method of claim 14, further comprising updating the property value based on the blockchain transaction data and the certification of completion.

16. A non-transitory computer readable medium comprising instructions, that when read by a processor, cause the processor to perform:
receiving property-related data comprising a current valuation of the property and at least one market comparable of the property;
providing the property-related data to a machine learning (ML) module for a property model generation;
receiving at least one predictive output of the property model; and
generating a property-related recommendation.

17. The non-transitory computer readable medium of claim 16, further comprising instructions, that when read by the processor, cause the processor to generate a return on investment (ROI) projection based on the property-related recommendation.

18. The non-transitory computer readable medium of claim 16, further comprising instructions, that when read by the processor, cause the processor to generate analytics data based on the property-related data, wherein the analytics comprising a current value of the property and an estimated future value of a property.

19. The non-transitory computer readable medium of claim 16, further comprising instructions, that when read by the processor, cause the processor to, responsive to the at least one property-related recommendation, orchestrate a third-party action between a property owner and a service provider.

20. The non-transitory computer readable medium of claim 19, further comprising instructions, that when read by the processor, cause the processor to track a completion of the third-party actions based on a blockchain transaction data and a certification of completion; and
update the property value based on the blockchain transaction data and the certification of completion.
